(19) United States
(12) Patent Application Publication
(10) Pub. No.: US 2023/0110728 A1
(43) Pub. Date: Apr. 13, 2023

(54) Coating Of Vehicular Interior Trim Apparatus

(71) Applicant: CpK Interior Products Inc., Port Hope (CA)

(72) Inventors: Gregory James FARRAR, Ontario (CA); Murali Mohan REDDY, Belleville (CA)

(73) Assignee: CpK Interior Products Inc., Port Hope (CA)

(21) Appl. No.: 17/499,142

(22) Filed: Oct. 12, 2021

(51) Int. Cl. C09D 5/14; B60R 21/2165; B60R 13/02; B60R 21/205; B05D 1/02; B05D 1/28; A01N 25/10; A01N 59/00

(52) U.S. Cl. CPC C09D 5/14; B60R 21/2165; B60R 13/0256; B60R 21/205; B05D 1/02; B05D 1/28; A01N 25/10; A01N 59/00; B05D 2201/02

(57) ABSTRACT

An apparatus and manufacturing method include a coating, including graphene particles, sprayed or rolled onto a base material. In another aspect, a coating, including antimicrobial or antiviral material, is sprayed or rolled onto a base material. A further aspect applies an antimicrobial material within a polymeric matrix onto a vehicular interior trim panel apparatus by roll-coating or spraying.

### BACKGROUND AND SUMMARY

The present application generally pertains to coated substrates and more particularly to roll or spray coating of a vehicular interior trim apparatus.

Traditionally, automotive vehicle instrument panel skins are made from a variety of polymeric materials including polyvinyl chloride (“PVC”), thermoplastic polyurethane (“TPU”), thermoplastic polyolefin (“TPO”) and thermoplastic elastomers (“TPEs”). These skins can be made by methods such as slush rotational molding and thermoforming. Examples are disclosed in U.S. Patent Publication No. 2017/0240736 entitled “Polyvinylchloride for Seamless Airbag Doors” invented by Farrar, and U.S. Pat. No. 7,560,515 entitled “PVC Alloy for Use in Air Bag Doors” which issued to Tansey on Jul. 14, 2009, both of which are incorporated by reference herein.

Furthermore, it is known to spray paint onto interior trim panels of automotive vehicles. For example, U.S. Patent Publication No. 2005/0096421 entitled “Aqueous Metallic Paint for Automobile Interior Materials and Coated Article” which published to Watanabe et al., teaches spraying a metallic colored paint onto a polypropylene, polyethylene, acrylonitrile-butadiene-styrene, polyvinyl chloride and polyurethane substrate. This patent publication merely includes titanium oxide, carbon black, iron oxide or chromium oxide inorganic pigments, organic pigments or conductive carbon pigments, in addition to a mica pigment, a water solvent, optionally an organic solvent, and additives. The Watanabe patent publication is incorporated by reference herein. This conventional spray paint is primarily aesthetic in nature rather than providing a functional benefit.

In accordance with the present invention, an apparatus and manufacturing method include a coating, including graphene particles, sprayed or rolled onto a base material. In another aspect, a coating, including antimicrobial or antiviral material, is sprayed or rolled onto a base material. A further aspect applies an antimicrobial material within a polymeric matrix onto a vehicular interior trim panel apparatus by roll-coating or spraying. Yet another aspect includes creating a flexible polymeric skin, curing the skin, applying a liquid polymeric and graphene layer on an outer surface of the cured skin, attaching the skin to a rigid substrate before or after the layer is applied, and optionally placing foam between the skin and the substrate before or after the layer is applied.

In an exemplary aspect, the antimicrobial material has antiviral activity and includes a polymeric matrix and graphene particles dispersed in the polymeric matrix at a concentration of greater than or equal to about 0.05 wt. % to less than or equal to about 10 wt. % based on the total weight of the antiviral material. In a further exemplary aspect, the antimicrobial material includes metal oxide particles dispersed in the polymer matrix, the metal oxide particles including at least one of cuprous oxide (Cu₂O) particles or zinc oxide (ZnO) particles. In another exemplary aspect, the base material is flexible and includes a polymer including flexible and/or rigid polyvinyl chloride (PVC), a thermoplastic elastomer (TPE), or a combination thereof, wherein the TPE includes a thermoplastic polyurethane (TPU), a thermoplastic polyolefin (TPO), thermoplastic vulcanizates (TPV), or combinations thereof. In yet another exemplary aspect, the base material is rigid and includes a polymer including polypropylene (PP), acrylonitrile butadiene styrene (ABS), polycarbonate (PC), PC/ABS, PC/PP, a thermoplastic elastomer (TPE), or combinations thereof.

The apparatus is useful as a Class-A surface of an automotive vehicle interior trim panel selected from the group consisting of an A-pillar, a B-pillar, a C-pillar, an instrument panel, a steering wheel skin, an airbag cover, a door trim panel, a center console, a knee bolster, a seat mechanism cover, and a sun visor. In an alternative example, the apparatus is also useful in non-automotive vehicle applications, such as for a seat, a bench, an exercise bench, a bicycle handle, a motorcycle handle, a vital signs monitor, hospital equipment, a door hand panel, a door foot panel, a door knob or handle, a door opening actuator, an airplane cabin wall, an airplane storage bin, an airplane seat, an airplane tray table, a cruise ship surface, a counter top, a flooring, a matt, an electrical device, a ski lift chair or rail, or a sports locker. In another example, the apparatus may be used to create a Class-A accessible, outer surface of a skin or cover material that resembles artificial leather for cushions or furniture such as a sofa, couch or chair. A method of applying a coating by rollers or spraying a polymeric matrix, including an antimicrobial material, to a base material is also provided.

The present apparatus and method are advantageous over conventional devices and materials. For example, the present apparatus and method use less antimicrobial and graphene material when roll-coated or sprayed, as compared to compounded into the skin or base materials. It is also beneficial to spray or roll-coat after the base material is formed since it may be desirable to not expose the antimicrobial coating to the same temperatures or pressures employed during base material forming. The present apparatus and method are also expected to be more cost effective at higher volume production. Because the present antimicrobial material has antiviral activity, it is especially useful for surfaces that are often touched by human subjects. Accordingly, the antimicrobial material is useful for destroying viruses, including coronaviruses, and decreasing risks of viral infection when contacting polymeric surfaces that are commonly encountered.

Moreover, severe acute respiratory syndrome coronavirus 2 (SARS-CoV-2) epidemic has changed the way hygiene is managed and maintained in public and other shared spaces. SARS-CoV-2, which causes coronavirus disease 2019 (COVID-19), and other deadly microbes can transmit through direct person-to person contact, from the uptake of contaminated airborne droplets, or even from contact with contaminated surfaces such as vehicle interiors. For example, traditional interiors of rental cars, taxis and other shared vehicles are affected by SARS-Covid-2, as the virus can be easily transmitted by coming in contact with it. Therefore, the present spray or roll-coating of antiviral polymeric materials on an accessible outer surface of a vehicular interior trim apparatus can beneficially significantly diminish the amount of virus present thereon. The present use of antiviral materials is an effective way to inactivate viral particles in the environment, which prevents viral transmission, thus lowering the risk of infection. Additional advantages and features of the present application will become apparent from the following description, attached drawings and appended claims.

### BRIEF DESCRIPTION OF THE DRAWINGS

FIG. 1 is a perspective view showing an interior trim panel including an antimicrobial coating in accordance with the present apparatus and method;

FIG. 2 is a cross-sectional view, taken along line 2-2 of FIG. 1, showing the interior trim panel;

FIG. 3 is a cross-section view showing an alternate embodiment base material including the antimicrobial coating in accordance with the present apparatus and method;

FIGS. 4A and 4B are flow diagrams of manufacturing steps employed to make the antimicrobial coating;

FIG. 5 is a flow diagram of manufacturing steps employed to make the interior trim panel and spray the antimicrobial coating thereon;

FIG. 6 is a diagrammatic view showing manufacturing steps employed to make the interior trim panel and roll-coat the antimicrobial coating thereon; and

FIG. 7 is a diagrammatic view showing a roll-coating apparatus for applying the antimicrobial coating onto a skin of the interior trim panel.

### DETAILED DESCRIPTION

The present apparatus and method include a layer or coating of an antimicrobial polymer on vehicular interior parts. Preferably, the vehicles are passenger automotive vehicles but the vehicles may alternately be aircraft vehicles such as airplanes, watercraft vehicles such as boats, and mass transportation wheeled vehicles such as buses, trains and subways. The automotive vehicle interior trim panels are preferably instrument panels, center floor consoles and door trim panels. Alternately, the automotive interior trim apparatuses may include soft skins, seating materials, class-A hard trim components, map-pockets, A-pillars, B-pillars, C-pillars, knee bolsters, seat mechanism covers, sun visors and the like.

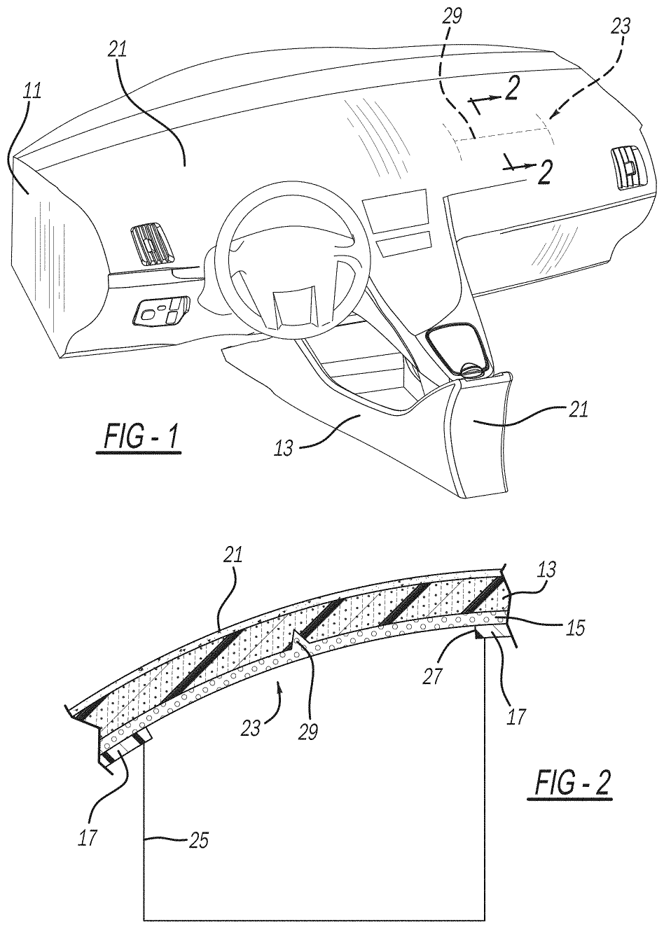

More specifically with reference to FIGS. 1 and 2, an interior trim apparatus for a wheeled automotive land vehicle is preferably an instrument panel 11 or a center floor-mounted console 13. Instrument panel 11 includes a base material, here an outer skin 13, a middle pliable foam layer 15 and an inner rigid substrate 17. An antimicrobial and antiviral coating layer 21 completely covers a user-accessible outer surface of skin 13 and is thinner than the skin. Coating layer 21 is flexible and provides a Class-A surface, while it also may optionally be pigmented, have gloss-reducing properties, contain ultraviolet light filtering additives and/or may exhibit stippling or other aesthetically pleasing patterns. Therefore, coating layer 21 synergistically provides an aesthetically pleasing anti-scuff protection while also exhibiting beneficial antimicrobial and antiviral protection to the trim panel. It is noteworthy that the present antimicrobial particles do not need to be in the skin itself since they are instead in the coating layer, thereby simplifying skin compounding and processing.

When used as an instrument panel 11, a section of skin 13 acts as an integral airbag door 23 behind which is an airbag assembly including a chute 25. Airbag door 23 hinges or pivots about upper and lower flexure lines adjacent generally horizontally elongated substrate edges 27 when an expanding airbag bursts tear seams 29 in skin 13. A “seamless” or hidden style of skin 13 is preferred whereby tear seams 29 are on the backside surface thereof and are not visible to the vehicle occupant or user. Tear seams 29 preferably have an H-shape, although other configurations such as U-shapes, and X-shapes can be employed.

Soft skins 13 for automotive interiors are made from a variety of polymeric materials including flexible PVC, TPU, TPO, and TPEs, by way of nonlimiting examples. These skins can be produced by methods such as slush rotational molding, injection molding, thermoforming, and from cut and sew applications.

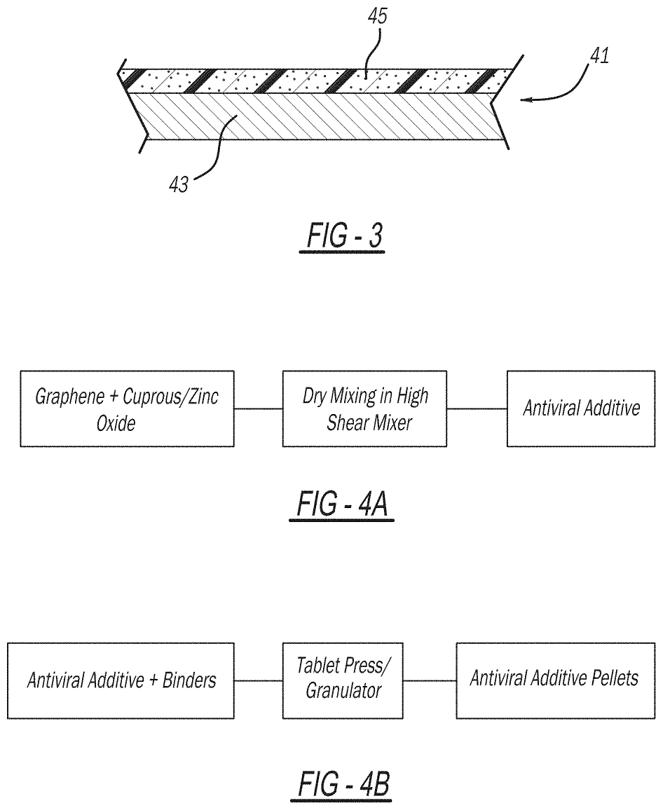

An elongated pillar trim panel, door trim panel, or alternately an exterior door handle apparatus 41, is shown in FIG. 3. Apparatus 41 includes a substantially rigid base material 43, such as stamped sheet metal or an injection molded ABS or polypropylene polymeric substrate, on an outer surface of which is antimicrobial material coating layer 45. Coating layer 45 is thinner than base material 43 and preferably no foam is therebetween. As used herein, the term “rigid” means that the “rigid” materials is substantially inflexible. In other words, the rigid materials may be bendable to a slight extent, but are at risk of cracking or breaking after a bending threshold is reached, such as may be exhibited by an automotive vehicle interior panel. On the other hand, “flexible” materials can be heavily bent or folded without cracking or breaking, such as may be exhibited by a synthetic leather.

Coating layer 21 includes an antimicrobial material or particles in a polymeric matrix. The antimicrobial material preferably includes graphene particles disposed and/or embedded in the polymeric matrix, including at an exposed exterior surface thereof. As used herein, the term “antimicrobial” preferably provides antiviral properties, antibacterial properties and/or antifungal properties. As such, when a virus contacts the antimicrobial material, the virus is disabled, inactivated, destroyed, or “killed” such that the virus is no longer capable of infecting a subject. Similarly, when the antimicrobial material has antibacterial properties, the bacterium is killed when a bacterium contacts the antimicrobial material. The term “antiviral” provides that the antiviral material disables, inactivates, destroys, or “kills” at least SARS-CoV-2, and in some aspects, also kills other viruses, including other coronaviruses. More specifically, the present antimicrobial material exhibits antiviral activity due to its ability to disrupt virus host cell recognition by denaturing protein structures on viral surfaces, leading to the inactivation of viruses regardless of the presence of a viral envelope. As nonlimiting examples, the antimicrobial material disables, inactivates, destroys, or “kills” greater than or equal to about 90%, greater than or equal to about 95%, greater than or equal to about 98%, greater than or equal to about 99%, such as about 90%, about 91%, about 92%, about 93%, about 94%, about 95%, about 96%, about 97%, about 98%, about 99%, or about 99.9%, of SARS-CoV-2 viral particles or plaque forming units (PFUs) in less than or equal to about 4 hours, less than or equal to about 3 hours, less than or equal to about 2 hours, less than or equal to about 1 hours, less than or equal to about 45 minutes, less than or equal to about 30 minutes, or less than or equal to about 15 minutes.

As used herein, a “polymeric matrix” preferably includes a water solvent and a water based polymeric material such as polyurethane, within which the antimicrobial particles, such as the graphene particles, are embedded or suspended. In the pre-cured and application condition, the polymeric matrix is in a liquid and flowable state, but after heat or UV curing, the polymeric matrix has a solid state. Depending on the use, such as on the instrument panel, the cured antimicrobial material preferably is flexible and soft, but it may alternately be relatively rigid. The hardness, rigidness, and flexibility of the antimicrobial material is provided by the polymer in the polymer matrix. For example, for applications requiring soft and flexible materials, such as for a synthetic leather or skin, as non-limiting examples, the polymer of the polymer matrix includes polyvinyl chloride (PVC), a thermoplastic elastomer (TPE), or a combination thereof. The TPE includes a thermoplastic polyurethane (TPU), a thermoplastic polyolefin (TPO), thermoplastic vulcanizates (TPV), or combinations thereof. Non-limiting examples of TPUs include reaction products of aromatic or aliphatic isocyanates with a polyether or polyester polyol, such as TEXIN® 3042 TPU (Covestro). Non-limiting examples of TPOs include olefin block copolymers (OBCs), INFUSE™ olefin block copolymer resins (Dow), ENGAGE™ polyolefin elastomer resins (Dow), styrene-ethylene-butylene-styrene (SEBS) polymer, such as KRATON™ SEBS polymer (Kraton), and the like. For applications requiring rigid materials, the polymer of the polymer matrix 312 includes polypropylene (PP), acrylonitrile butadiene styrene (ABS), polycarbonate (PC), PC/ABS, PC/PP, a TPE, or combinations thereof. Non-limiting examples of TPUs include aliphatic and aromatic TPUs, such as TEXIN® TPUs (Covestro). Non-limiting examples of hard TPEs include OBCs, INFUSE™ olefin block copolymer resins (Dow), ENGAGE™ polyolefin elastomer resins (Dow), styrene-ethylene-butylene-styrene (SEBS) polymer, such as KRATON™ SEBS polymer (Kraton), and the like.

The graphene particles are antimicrobial particles or flakes including graphene or a graphene derivative, such as graphene oxide as a non-limiting example, that provide at least the antiviral activity. The graphene particles have greater than or equal to 1 to less than or equal to 10 layers or greater than or equal to 6 to less than or equal to 10 layers, wherein each layer includes carbon atoms arranged in a two-dimensional honeycomb-shaped lattice. In various aspects, the graphene particles have 1, 2, 3, 4, 5, 6, 7, 8, 9, or 10 of the layers. The graphene particles each have a diameter of greater than or equal to about 750 nm to less than or equal to about 250 μm, greater than or equal to about 1 μm to less than or equal to about 100 μm, or greater than or equal to about 1 μm to less than or equal to about 50 μm.

Details on the antiviral composition can be found in commonly owned U.S. patent application Ser. No. 17/411,415, filed on Aug. 25, 2021, and entitled “Graphene-Based Antiviral Polymer” which is incorporated by reference herein. Further details can be found in commonly owned U.S. patent application Ser. No. 16/802,830, filed on Feb. 27, 2020, entitled “Urethane and Graphene Interior Trim Panel” which is also incorporated by reference herein.

Without being bound by theory, the antimicrobial properties of graphene, and graphene-derivatives (e.g., graphene oxide), are attributed to their electron movement towards microbes. This migration causes cytoplasmic efflux, decreases metabolism, affects lipid membrane, induces oxidative stress, produces reactive oxygen species (ROS), loss of glutathione, and finally causes microbial death. As non-limiting examples, graphene can be used to kill different coronaviruses, including SARS-CoV strains.

In some aspects, the antimicrobial material includes an additional antimicrobial agent. By way of example, the antimicrobial material further includes metal oxide particles, wherein the metal oxide particles also provide at least antiviral activity. The metal oxide particles may optionally include cuprous oxide (Cu₂O) particles, zinc oxide (ZnO) particles, silver oxide (Ag₂O), or combinations thereof. These metal oxide particles release antimicrobial ions, such as Cu¹⁺, Ag¹⁺ and/or Zn²⁺, and are used to prepare antimicrobial surfaces. Graphene and/or graphene oxide can promote antimicrobial activities of these ions further and improve the effectiveness. The metal oxide particles each have a diameter of greater than or equal to about 100 nm to less than or equal to about 100 μm, greater than or equal to about 200 nm to less than or equal to about 10 μm, greater than or equal to about 250 nm to less than or equal to about 5 μm, or greater than or equal to about 250 nm to less than or equal to about 1.8 μm.

The graphene particles and the metal oxide particles are individually uniformly dispersed throughout the polymeric matrix of coating layer 21. By “individually uniformly dispersed,” it is meant that the graphene particles and the metal oxide particles are blended within the polymer matrix, including the solvent, without respect to each other. Inasmuch as some graphene particles and metal oxide particles may be in contact with each other, the contact is random and an artifact of a mixing step of a fabrication method for the antimicrobial material. Therefore, contact between a portion of the graphene particles and a portion of the metal oxide particles is not intended, but may be present.

Moreover, coating layer 21 can also include adjunct agents, such as solvent (water/urethane) plasticizers, compatibilizers, impact modifiers, light an UV stabilizers, heat stabilizers, color pigments, fillers (e.g., glass fibers), talc, minerals, glass, physical or chemical foaming agents, and combinations thereof. The graphene particles have a concentration in the coating layer of 60-100 wt. %, and if optionally present, the Cuprous and/or Zinc Oxide particles have a concentration of 5-40 wt. %, based on the total weight of the antimicrobial material in the coating layer. Preferably, the antimicrobial material is about 1-20% of the total coating material. Furthermore, coating layer 21 (including the antimicrobial material, PU polymer matrix and water solvent) is about 0.5 wt % to 5 wt % of the entire coated skin combination 21 and 13, by way of nonlimiting example.

The manufacturing methods will now be discussed. First, FIG. 4A illustrates the antimicrobial particles, such as Graphene and optionally Cuprous and/or Zinc Oxides, being dry mixed in a high shear mixer to create an antiviral additive. Second, the antiviral additive and binders are compounded together and pressed into tablets in a granulator machine to create antiviral and additive pellets for storage and further use, as can be observed in FIG. 4B.

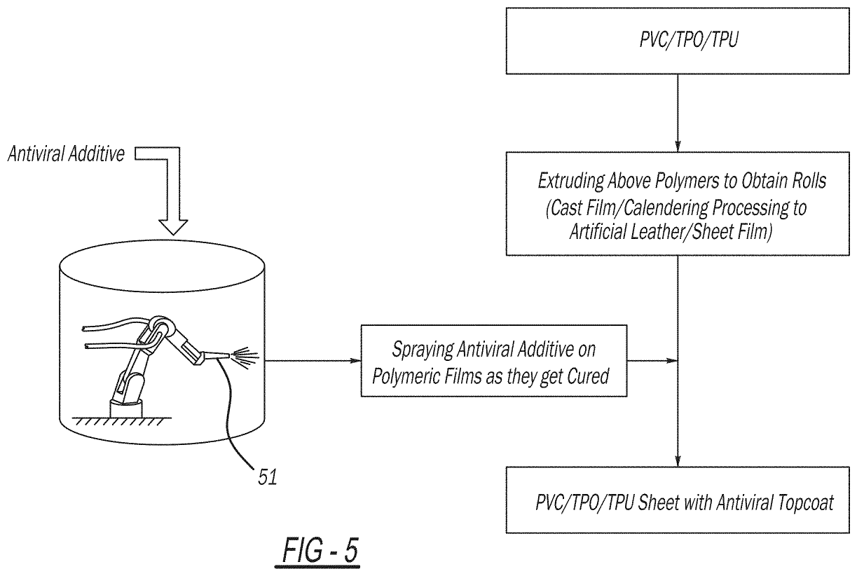

In one embodiment, a third step includes pre-forming the interior trim panel by slush molding the skin in a liquid state within rotating and heated molds from a TPU, PVC or TPO material, or vacuum thermoforming into an open mold is employed, which is then cured and cooled. A rigid substrate or frame is also injection molded from an ABS, PP, nylon or other polymeric material within molds and then cured and cooled. Subsequently, the pre-formed skin is placed over a portion of the pre-formed substrate, and optionally, a pliable foam is injected therebetween and cured, which secures the skin onto the substrate. In this processing embodiment, the antimicrobial coating layer matrix is fed, in a primarily liquid state, from one or more holding tanks to an applicator via one or more elongated hoses. The coating layer matrix is sprayed onto an outer surface of the pre-formed skin via the applicator, here a robotic or hand-held spray gun 51 as shown in FIG. 5, which has a spray nozzle which atomizes and sprays the mixed coating material. The robotic applicator is shown to include articulating arms and a rotatable head to hold spray gun 51, but it can alternately be a gantry style robot.

In a second processing embodiment more completely shown in FIG. 5, the third step includes feeding raw PVC, TPO or TPU polymeric skin material into an extruding machine which heats and extrudes out the skin material into an elongated thin sheet of generally constant thickness and of flat shape, which is then cured, cooled and rolled for storage and later use. Next, the extruded skin material is sprayed with the liquid coating material via at least one applicator spray nozzle to create a uniform layer of the coating including the antiviral particles and polymeric matrix. The coating layer is subsequently cured and/or cooled. If the skin moves through the coating station in a continuous manner, then the coated skin sheet is optionally cut to individual part sizes via a steel rule knife, water jet cutter or a laser cutter. Thereafter, the coated skin combination is thermoformed or otherwise molded into the final desired shape, and then it is assembled to a separately formed or molded substrate.

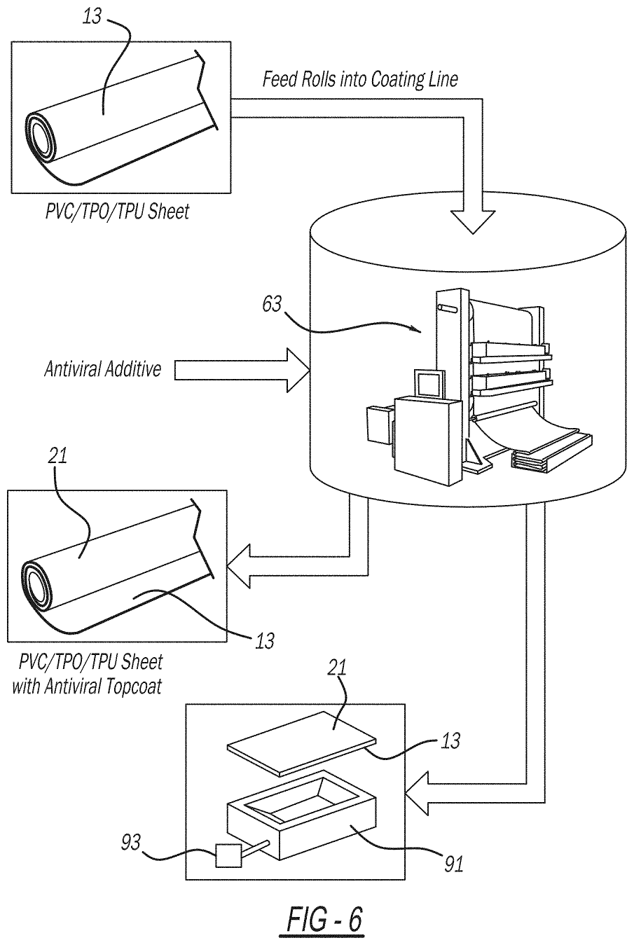

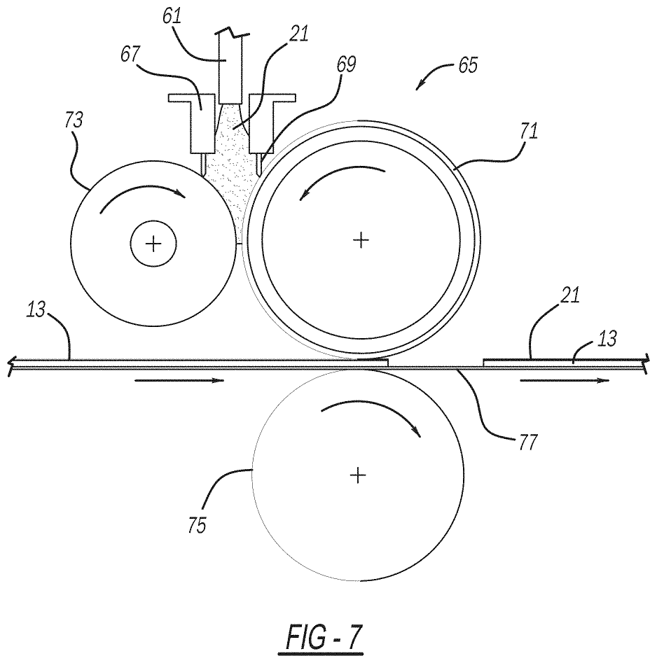

A third processing embodiment is illustrated in FIGS. 6 and 7. The skin material 13 is extruded into a uniform sheet and rolled, as previously discussed. The liquid coating material 21, including the antiviral/antimicrobial particles and the polymeric matrix, are fed from an applicator nozzle 61 into a vertically oriented roll coating or calendaring machine 63 (FIG. 6) or between rollers of a horizontally oriented roll coating or calendaring machine 65 (FIG. 7). Machine 65 includes a nip 67, scraper blades 69, a larger diameter application roll 71, and a smaller diameter doctor roll 73. A lower support roll 75 is on an opposite side of a conveyor 77 than is the aligned application roll 71. Each of the rolls 71, 73 and 75 all rotate about generally parallel axes. Coating material 21 downwardly flows between rolls 71 and 73 thereby temporarily coating an outside periphery of application roll 71 when then applies it onto a facing outer surface of flat skin 13 as the skin (on the conveyor) moves between application roll 71 and support roll 75. If the skin moves through the coating station in a continuous manner, then the coated skin sheet is thereafter optionally cut to individual part sizes via a steel rule knife, water jet cutter or a laser cutter.

For any of the embodiments herein, the curing is preferably done by moving the coated skin through an oven. Such an oven may be heated by internal radiant resistive wire coils, convection heating, microwave emitters and/or infrared heaters.

Thereafter, the coated skins are placed onto an open mold 91 (see FIG. 6). A vacuum pump 93 provides vacuum pressure to pull the coated skin into the contoured and heated mold to form the coated skin into a desired final shape. The shaped, coated skin is then cured and cooled. Finally, the formed skin is attached to a separately molded substrate, with optionally foam placed therebetween. Roll coating advantageously provides fast coating of a large quantity of skins at a uniformly controlled thickness.

While various features of the present invention have been disclosed, it should be appreciated that other variations may be employed. For example, the coating of the present apparatus and method may alternately be applied to other base materials such as synthetic leather, gym equipment, flooring, wallets, medical instruments or medical plastics, electronics (e.g., touch screen, buttons, housings, keyboards, laptops, and the like), public transit surfaces such as benches and handrails, cruise ship interior surfaces, sports equipment, and plastic door handles/pads, among others. An automotive interior trim panel, created by spraying or roll coating an antimicrobial or antiviral material onto a generally flat or three-dimensionally shaped polymeric skin, is also envisioned herein. Each and all of the above-disclosed components and method steps can be combined or re-ordered in any combination. Individual elements or features of a particular embodiment are generally not limited to that particular embodiment, but, where applicable, are interchangeable and can be used in a selected embodiment, even if not specifically shown or described; the dependent claims may also be multiply dependent on each other in any combination. Variations are not to be regarded as a departure from the present disclosure, and all such modifications are intended to be included within the scope and spirit of the present invention.

The invention claimed is:

1. A method of manufacturing an apparatus comprising a base material, the method comprising:
(a) feeding a liquid coating material comprising an antimicrobial material to an applicator; and
(b) coating the liquid material upon an outside surface of the base material, the base material being flexible at least before the coating.

2. The method of claim 1, wherein the coating comprises spraying.

3. The method of claim 2, further comprising moving a robotic head, which includes a spray nozzle, to spray the liquid material upon the base material.

4. The method of claim 1, wherein the coating comprises roll coating.

5. The method of claim 4, further comprising rotating multiple rolls above the base material, moving a sheet of the base material along a conveyor, the applicator flowing the liquid coating material between the rolls, and at least one of the rolls applying the liquid coating material upon an upper surface of the base material.

6. The method of claim 1, further comprising creating an automotive vehicle interior trim panel from the antimicrobial coated base material.

7. The method of claim 1, further comprising creating an automotive vehicle instrument panel from the antimicrobial coated base material.

8. The method of claim 1, further comprising slush molding the base material in a rotational mold to create a three-dimensionally formed skin of polymeric material, applying the coating material as a Class-A accessible surface onto the skin, and mounting the skin onto a rigid substrate.

9. The method of claim 1, further comprising forming the base material as a substantially flat polymeric sheet of substantially uniform thickness prior to the flat sheet being coated with the antimicrobial material, cutting the coated base material, and molding the antimicrobial coated base material into a three-dimensionally formed interior trim panel in a heated mold after the coating.

10. The method of claim 1, wherein a layer of the antimicrobial material is thinner than the base material, the antimicrobial material is flexible when cured on the base material, the antimicrobial material comprises antiviral graphene particles within a polymeric matrix, and the antiviral particles are about 1-20% of the total coating material.

11. A method of manufacturing an antiviral apparatus, the method comprising:
(a) forming a base material;
(b) feeding a liquid material, comprising graphene antiviral particles in a polymeric matrix, to an applicator;
(c) applying a layer of the liquid material from the applicator upon a surface of the formed base material;
(d) curing the applied liquid material on the base material;
(e) the layer of the cured liquid material being thinner than the base material.

12. The method of claim 11, wherein the applying comprises spraying.

13. The method of claim 12, further comprising moving a robotic head, which includes a spray nozzle, to spray the liquid material upon the base material which is flexible before and after the spraying and curing.

14. The method of claim 11, wherein the applying comprises roll coating.

15. The method of claim 11, further comprising creating an automotive vehicle interior trim panel from the antiviral covered base material which is polymeric.

16. The method of claim 11, further comprising creating an automotive vehicle instrument panel from the antiviral covered base material which is polymeric.

17. The method of claim 11, further comprising slush molding the base material in a rotational mold to create a three-dimensionally formed skin of polymeric material, applying the antiviral material as a Class-A outside surface onto the skin, and mounting the skin onto a rigid substrate.

18. The method of claim 11, further comprising forming the base material as a substantially flat polymeric sheet of substantially uniform thickness prior to the flat sheet having the antiviral material applied thereto, and molding the antiviral covered base material into a three-dimensionally formed interior trim panel in a heated mold after the antiviral material is applied.

19. The method of claim 11, wherein the antiviral material is flexible when cured on the base material, the antiviral material comprises graphene particles within a polymeric matrix, and the graphene particles are about 1-5% of the total antiviral material.

20. A method of manufacturing an automotive instrument panel, the method comprising:
(a) forming a flexible polymeric skin;
(b) feeding an antiviral material to a spray gun or rolls;
(c) coating the antiviral material from the spray gun or rolls onto a surface of the formed skin.

21. The method of claim 20, further comprising:
curing the coated antiviral material on the skin;
mounting the skin upon a rigid substrate;
placing pliable foam between the skin and the substrate;
the antiviral material being in a primarily liquid state during the feeding; and
the antiviral material being thinner than the skin.

22. The method of claim 20, wherein the spray gun sprays the antiviral material, which includes graphene, onto the skin which is pre-formed in a mold to a final desired shape.

23. The method of claim 20, wherein the spray gun sprays the antiviral material, which includes graphene, onto the skin which is substantially flat and of uniform thickness prior to the coating, and subsequently forming the skin to a final desired shape after the coating.

24. The method of claim 20, wherein the rolls are rotated to apply the antiviral material, which includes graphene, onto the skin which is pre-formed in a mold to a final desired shape.

25. The method of claim 20, wherein the rolls are rotated to apply the antiviral material, which includes graphene, onto the skin which is substantially flat and of uniform thickness prior to the coating, and subsequently forming the skin to a final desired shape after the coating.

26. The method of claim 20, wherein the forming comprises slush molding the skin in a rotational mold to create a three-dimensionally formed skin of TPU or PVC material, the antiviral material is a Class-A outside surface on the formed skin, and further comprising mounting the skin onto a rigid substrate.

27. An automotive vehicle apparatus comprising:
a flexible skin comprising an antiviral material;
a rigid substrate;
the antiviral layer comprising a polymeric matrix and graphene particles dispersed within the polymeric matrix at a concentration of greater than or equal to about 0.05 wt. % to less than or equal to about 10 wt. % based on the total weight of the antiviral layer;
the antiviral layer being attached to an outer surface of the skin;
the antiviral layer being thinner than the skin;
the skin being coupled to the substrate; and
the antiviral material exhibiting antiviral activity on a user accessible surface of the apparatus which is an automotive vehicle interior trim panel.

28. The automotive vehicle apparatus of claim 27, wherein the antiviral layer further comprises at least one of cuprous oxide (Cu₂O) particles or zinc oxide (ZnO) particles.

29. The automotive vehicle apparatus of claim 27, further comprising compressible foam located between the skin and the rigid substrate, the interior trim panel being an instrument panel, and an airbag cover portion of the skin comprising a tear seam on a surface thereof.

30. The automotive vehicle apparatus of claim 27, wherein the skin comprises polyvinyl chloride (PVC), thermoplastic polyurethane (TPU), thermoplastic polyolefin (TPO), thermoplastic vulcanizate (TPV), or a combination thereof.
